(19) United States
(12) Patent Application Publication
(10) Pub. No.: US 2007/0078742 A1
(43) Pub. Date: Apr. 5, 2007

(54) Implementation of a prime broker to consolidate OTC derivatives exposures

(76) Inventor: Lucio Biase, New York, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 11/528,899

(22) Filed: Sep. 27, 2006

Related U.S. Application Data
(60) Provisional application No. 60/720,939, filed on Sep. 27, 2005.

(51) Int. Cl. G06Q 40/00

(52) U.S. Cl. 705/36 R; 705/37

(57) ABSTRACT

An interface that facilitates reporting, settlement, and financing charges for the fields of swaps (credit default, interest and other) and bond options. A system for aggregating, organizing, reporting and settling Over the Counter (“OTC”) derivative trades. Many clients refrain from trading Credit Default Swaps (“CDS”) due to the heavy documentation and disclosure requirements mandated by each counterparty: International Swaps and Derivatives Association, Inc. (“ISDA”), Credit Support Annex (“CSA”) and Trade Confirm. This solution applies a Prime Broker and give-up agreements. The backlog of unsigned confirms has allowed for electronic novations (assignments). A Prime Broker can stand in between their client and all their counterparties to lessen the documentation burdens.

This application claims priority from U.S. Provisional Application Ser. No. 60/720,939, filed Sep. 27, 2005, the entire disclosure of which is hereby incorporated by reference herein.

### FIELD OF THE INVENTION

The present invention generally relates to an interface that facilitates reporting, settlement, and financing charges for the fields of swaps (credit default, interest and other) and bond options.

### BACKGROUND OF THE INVENTION

The Credit Default Swaps (“CDS”) market has burgeoned to over $26 trillion. This derivative market now eclipses the cash market from which it is derived. In May of 2005, Alan Greenspan said, “Perhaps the most significant development over the past ten years has been the rapid development of credit derivatives.” He also warned, “To be sure, the benefits of derivatives, both to individual institutions and to the financial system and the economy as a whole, could be diminished, and financial instability could result, if the risks associated with their use are not managed effectively.”

CDS is a cross between purchasing insurance on a bond and a Put option that can only be triggered by an event of default. The holder of the credit protection (the buyer of CDS) basically has an insurance policy on the bond, unlike a bond option where premiums are paid upfront, the premiums are paid Quarterly/Semi annually over the length of the contract.

According to the International Swaps and Derivatives Association, Inc. (“ISDA”) the notional amount of CDS grew by 52% in first half of 2006 to $26.0 trillion from $17.1 trillion, up 109% from $12.4 trillion at mid-year 2005. Participants in this Over the Counter (“OTC”) derivatives market desire to preserve balance sheet, the growth of index products (including synthetic collateralized debt obligations) and greater liquidity have fueled the exponential growth of the CDS market.

While Mr. Greenspan's words may have a hint of hyperbole, CDS is a true derivative instrument: it is a zero sum game. There are an equal number of winners and losers for a given trade, the risk is in the redistribution of P&L due to credit and settlement risks. CDS is an individually negotiated derivative contract between two parties. Although there are industry standard contract conventions, it is not exchange cleared. A large amount of the staggering $26 trillion figure does not reflect true risk, but legacied exposures.

Market practice is for these transactions to be individually negotiated contracts between two counterparties. While organizations such as ISDA have standardized many of the market conventions that fuel the liquity and growth of this market, a portion of these trades remain unconfirmed or delayed.

Unfortunately the only thing that has kept pace with the growth of CDS trading is the backlog of confirms and the need for a market friendly solution. This lack of infrastructure has only recently been addressed in the United States and Europe. While the Federal Reserve has published reports since 1996 on CDS (SR letter 96-17) it is just in September of 2005 that the Federal Reserve addressed the unspoken terror of settlement issues in this trillion dollar industry.

While the adoption of standard languages (such as FPML) have aided the conformation process and organizations such as the Depository Trust & Clearing Corporation (“DTCC”) afford counterparties a platform to report their positions, there is a need for a credit-worthy entity to stand in between these counterparties taking settlement and counterparty credit risk but not market risk: an exchange or clearing agent.

### SUMMARY OF THE INVENTION

An object of the present invention is to provide a system for aggregating, organizing, reporting and settling OTC derivative trades. Many clients refrain from trading CDS due to the heavy documentation and disclosure requirements mandated by each counterparty: ISDA, Credit Support Annex (“CSA”) and Trade Confirm. This solution applies a Prime Broker and give-up agreements. The backlog of unsigned confirms has allowed for electronic novations (assignments). A Prime Broker can stand in between their client and all their counterparties to lessen the documentation burdens.

### BRIEF DESCRIPTION OF THE DRAWINGS

FIG. 1 shows a current trading process: Currently investors face the counterparty that they originally traded with.

FIG. 2 shows a current trading pile-up: With relatively low trading volume, exposures to counter parties pile up.

FIG. 3 shows the advent of a Prime Broker: By introducing a Prime Broker, the investor has only to face one counter party. The Prime Broker will now consolidate the investor's positions.

FIG. 4 shows Prime Broker consolidating positions: The Prime Broker consolidates the investor's positions reducing $28 million of outstanding trades to $2 million, freeing collateral, saving the investor financing charges and from legacied exposure, while reducing scores of future cashflows to just two (one to close the Company 1 trade and one to net the Company 2 position).

### DETAILED DESCRIPTION

The present invention addresses the following eight issues market participants face:

1) Phantom P&L, including Swap Curve Movements, changes in Underlying Credit Spreads, and Event of Default (remote event);

2) Messy Confirmation Process, such as when they are not Exchange cleared or there is no custodian. DTCC (FPML) has tried to arrange a way to confirm electronically, few banks have adopted this process;

3) Reporting from one source, one file format, daily;

4) Assignments and Unwinds. Assignments are a complicated process, often involving the coordination of both banks' sales desks and back office personnel who have to monitor collateral and wait until month-end if even reported;

5) Cash payments, in and out when trader shows no position, realizations of cash flows, premium paid over life on the contract, it is difficult to tie cash payments to specific trades without a clearing house;

6) Large exposures to various banks. Often these positions offset and provide counterparty risk management with an exaggerated view of risk/positions and leverage;

7) Balance sheet usage. All banks require collateral (both long and short), and not being able to net positions ties up more of the balance sheet in collateral;

8) Funding Costs. Assumption is that all funds hold more assets than equity. Freed collateral would allow funds to borrow less.

The Prime Broker Solution remedies the issues market participants face and will be welcomed by both active CDS trading accounts and those that were on the sidelines. It will benefit both the buy and sell sides in the following ways:

The Buy Side benefits include:

Reduced balance sheet usage, as most funds have more assets under management than equity, un-netted collateral requirements eat-up a balance sheet and increase funding costs, which is clear in examples of boxed or offsetting positions of single name CDS, most beneficial in index trading, and allows counterparties to net bonds vs. CDS contracts for Credit Risk Management;

Legal requirements (reduced paperwork and reporting), including one ISDA and many “Give-Up Agreements”, which are essentially shorter form and less stringent trade agreements;

One point of contact, including one source for all open positions, one file format (a more user friendly interface than FPML), and an aggregation of Cash Flows (cash flows tied to specific trades);

Facilitated settlement, including a short form electronic conformation for new trades and an electronic assignment for older trade novations (2005 ISDA Protocol);

Greater transparency in reporting, including reporting of positions based on reference obligation by any and all criteria such as credit rating, industry, company, spread level, duration (both credit and interest), maturity and payment dates;

Provide marks for valuation and collateral requirements for the entire book's positions.

Prime Brokers standing in between the buy side and the dealers allow for more efficient netting of collateral that enables the buy side to benefit from lower funding costs, greater transparency and automation.

The Prime Broker is compensated in any of a number of ways, including a brokerage fee based on notional amount of the trade $x per million notional for investment grade credits $y per million notional for credits that are five B's or below or that are not rated. The brokerage fee may be waved for trades done in house but may also be contingent on any of the following criteria, but not limited to: maturity/duration of the contract; credit rating of the reference obligation; contract spread/current market spread; defined by the index of names (for multiname CDS vs. single name contracts); sovereign vs. corporate credits; credit worthiness of the counterparty employing the Prime Broker; historical or implied volatility of the reference obligor (equity or debt). Prime brokers may also benefit from the borrow they pay in the requisite collateral, such as by benefiting from the difference in the amount of collateral they may owe to either side of the contract and/or benefiting from netting of positions with the counterparties they face. Prime Brokers may also benefit similarly to what has been witnessed in the foreign exchange markets. Prime Brokers' front offices may also benefit from increased trading volumes as fee structure encourages counterparties to “trade direct” either when initiating new trades or flattening balances.

A further object of the present invention is for it to apply to other asset classes such as bond options, interest rate swaps and synthetic CDO's, for example.

Following are several trade examples:

A first example is where an investor purchases CDS and purchases $10 M notional of protection from an investment Bank A at a rate of Libor (L) plus 300 bp for 5 yrs of protection. The current market being L+300 bp and equal to the cost of protection in the derivative contract (usually in the form of an ISDA agreement): there is no P&L associated with this trade example as the purchaser (investor) pays the seller of protection (market maker) 300 bp of $10 M paid quarterly. Neither the market maker nor the investor has demanded collateral from the other party as the marking to market of the position is zero.

A second example is where an investor sells CDS and sells $10 M notional of protection to market maker B at a rate of Libor (L) plus 50 bp for 5 yrs of protection. The current market being L+50 bp and equal to the cost of protection in the derivative contract: there is no P&L associated with this trade. The seller of protection has a running cost due to the collateral they are forced to pledge for writing this option. The true cost of this collateral is often overlooked and is proportional to the amount of cash a fund may have on its books and its borrowing costs (haircuts and funding rates). Being that the investor is writing an option in the form of a CDS contract, it is customary for the bank to request collateral to mitigate the credit risk of the writer.

A third example is where an investor purchases CDS, and the company reports fantastic earnings due to a new product patent and their five year credit rallies from L+300 bp to L+50 bp; protection may be bought for one sixth the cost of the initial trade. The 250 bp loss is compounded by the rally for the following two factors: a smaller discount rate, the expected cashflows being no longer discounted by swaps plus 300 bp but swaps plus 50 bp; and the expected time to default increases so that the probability of default is less (duration extends and it is more likely that all CDS cashflows will be incurred as the company is less likely to default during the term of the contract). The writer of the protection at 300 bp now demands collateral from the investor to reduce the counterparty credit risk. The bank fears that the investor would no longer pay 300 bp to insure a credit when they could buy it for 50 bp away. Unlike a simple bond option, CDS payments are spread over the term of the contract and not a lump sum at the beginning of the trade. If the buyer of protection (the investor) were to walk away from the trade, the option writer would be out the PV of the CDS payments, in this case >$1.1 M.

Trade Summary: Buying and Selling CDS. In this trade example, a company buys and sells CDS on a name that rallies. Although the trader will assume that he/she is flat the credit, simply buying and selling protection will lead to: Balance sheet usage, being required to provide collateral on both legs; legacied funding costs, borrowing to fund required collateral; phantom P&L, the difference in the future cashflows will vary as a function of swaps and credit spreads; continuous cashflows, if traded in the first quarter this “closed” position will lead to 40 separate wires; and maturity offsets, may be (but not necessarily) exposed for a payment period at the tail of the contract. This is all predicated on the trader not asking the initial counterparty for a level to Unwind the trade or having another bank give a market quote on an Assignment. Although Unwind may be the most logical termination, it may not be the most economic: reliance on one counterparty that knows a particular side. Assignment takes the most of the trader's time, may not be quoted on the run, and may be a complicated settlement process as someone has to coordinate both counterparties' front and back offices on a trade that doesn't involve them. Many buy-side shops, traders and back offices are unaware of balance sheet issues caused by CDS. A Prime Broker standing in between the hedge fund and the banks can offer one point to resolve this.

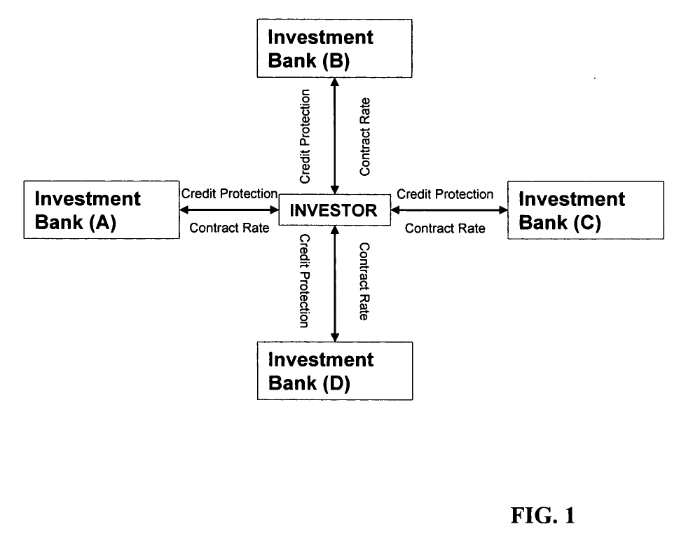

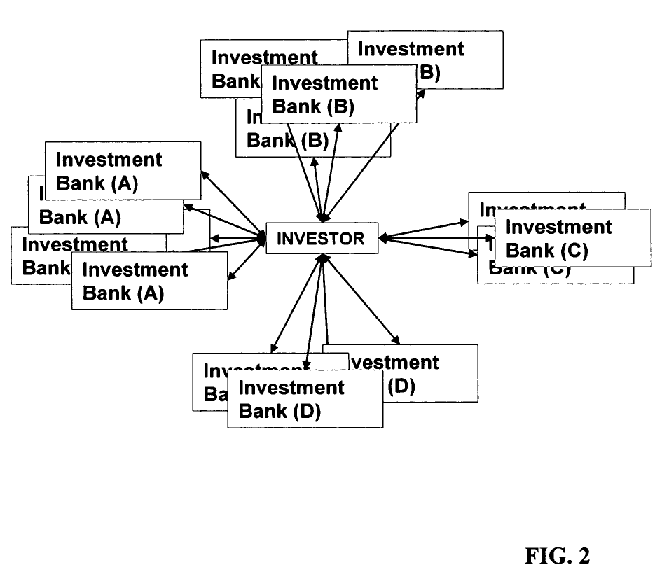

In the current trading process, market participants (investors and market makers, namely Market Makers) face the counterparty they originally traded with (see FIG. 1). As investors trade in and out of positions, these exposures pile up with relatively low trading volumes (see FIG. 2).

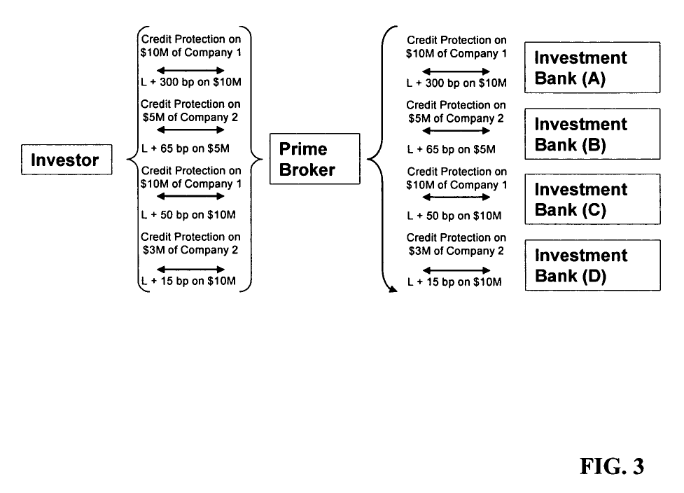

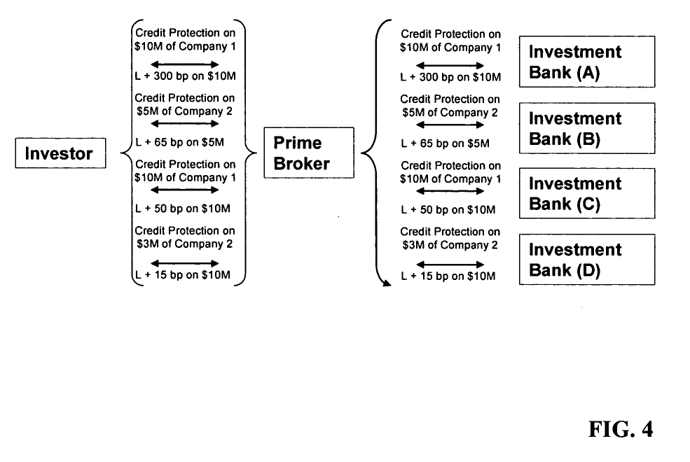

With the advent of Prime Broker, the investor has only to face one counterparty, the Prime Broker. For a fee, the Prime Broker will both long and short the position (see FIG. 3). The Prime Broker will consolidate the Investor's positions (see FIG. 4). The Prime Broker consolidates the hedge fund's positions reducing $28 million of outstanding trades to $2 million, freeing millions in collateral, saving the fund financing charges and from phantom P&L, while reducing scores of future cashflows to just two (one to close the Company 1 trade and one to net the Company 2 position).

What is claimed is:

1. A prime broker for credit derivative (CD) and/or bond options, the CD and/or bond options having buyers and sellers, the prime broker comprising:
a first interface with at least one buyer of a first CD or bond option, and
a second interface with at least one seller of the first CD or bond option,
the prime broker being both long and short on the first CD or bond option, the seller and buyer having recourse only with the prime broker for the first CD or bond option.

2. The prime broker as recited in claim 1 wherein the prime broker is a rated counterparty.

3. The prime broker as recited in claim 1 wherein an electronic trade of first CD or bond option is assigned to the prime broker either at or after trade.

4. The prime broker as recited in claim 1 wherein trade details of the first CD or bond option are agreed to initially by the buyer and seller.

5. The prime broker as recited in claim 1 wherein the buyer is a hedge fund.

6. The prime broker as recited in claim 1 wherein the seller is an investment bank.

7. The prime broker as recited in claim 1 wherein the buyer sells a second CD or bond option, the prime broker netting the first CD or bond option against the second CD or bond option so that the buyer has a netted exposure to the prime broker.

8. The prime broker as recited in claim 1 wherein the buyer or seller has a negotiated international swaps dealer association (ISDA) contract and collateral agreement with the prime broker.

9. The prime broker as recited in claim 1 wherein the prime broker reports positions to the buyer or seller based on a reference obligation by at least one of the following criteria: credit rating, industry, company, spread level, credit duration, interest duration, maturity, payment dates.

10. The prime broker as recited in claim 1 wherein the buyer buys a CD with a confirmation listing the following trade details: Maturity of Contract, Reference Obligation, Notional Amount, Payment Amount, Payment Frequency and Day Count Methodology, Settlement Date, Trigger (event of default) and Delivery Options if Event of Default occurs, and Master Agreement Reference.

11. The prime broker as recited in claim 1 wherein the buyer buys a bond option with a confirmation listing the following trade details: Maturity of Option, Reference Obligation, Notional, Put/Call, Strike (and Barriers/triggers if applicable), Option type (European, American, Bermudean or a hybrid), Notification

12. The prime broker as recited in claim 1 wherein the buyer and seller have an active give-up or third party agreement for trading CD or bond options.

13. The prime broker as recited in claim 1 wherein the CD is a credit default swap.

14. The prime broker as recited in claim 13 wherein the credit default swap references a single name or an index.

15. A method for providing a prime broker for credit derivative (CD) and/or bond options, the CD and/or bond options having buyers and sellers, the method comprising:
communicating with at least one buyer of a first CD or bond option, and
communicating with at least one seller of the first CD or bond option,
the prime broker after the communicating being both long and short on the first CD or bond option, the seller and buyer having recourse only with the prime broker for the first CD or bond option.
